(19) United States
(12) Patent Application Publication
(10) Pub. No.: US 2003/0216081 A1
(43) Pub. Date: Nov. 20, 2003

(54) ELECTRICAL CONNECTION AND WIRING OF SOCKETS

(76) Inventor: Jerry Salvatore Trainello, Sarasota, FL (US)

Correspondence Address: JERRY TRAINELLO, 4947 TAYWATER DELL, SARASOTA, FL, 34235, US

(21) Appl. No.: 10/199,910

(22) Filed: Jul. 19, 2002

Related U.S. Application Data
(60) Provisional application No. 60/381,861, filed on May 18, 2002.

(51) Int. Cl. H01R 4/24

(52) U.S. Cl. 439/416

(57) ABSTRACT

An improved socket assembly comprising a common metal screw shell riveted to an insulated base, connected to the screw shell is an elongated conductive strip that extends down the side of the insulated base.

The center bulb contact is also riveted to the insulated base and also has an elongated conductive strip extending down the opposite side of the insulated base. Both elongated conductive strips have holes for screws, one above center the other below center so as not to interfere with each other when making electrical contact. The insulated base has two threaded screw holes opposite each other that line up with the holes in the conductive strips.

A close fitting channel is provided in the insulated base for the insertion of the insulated lamp wire. This channel is approximately three eighths of an inch deep. Upon insertion of the lamp wire in the channel and the tightening of the two contact screws one from each side, electrical contact is made quickly and safely. Whereby this connection will hold a 35-lb. weight in tension for 24 hours or more without pulling apart or losing electrical connection.

### CROSS-REFERENCE TO RELATED APPLICATIONS

This application claims the benefit of PPA Application No. 60/381,861 Filing Date May 18, 2002

### BACKGROUND OF THE INVENTION

1. Field of Invention

This invention relates to electric lamp sockets, specifically to an improved Electrical connection and simple wiring.

2. Background of the Invention

Socket assemblies are divided into switched or non-switched. Regardless of the type, anyone who has ever wired a socket is aware of how time consuming it is. Each half must be stripped of the insulation to expose the wires without cutting the individual wire strands. Each set of strands must be twisted. Then all strands of wire must be coiled around two screw terminals and screwed down firmly, with the hope of not to many strands of wire coming loose from under the screw head. If a lamp is being wired a knot is usually tied in the insulated wire at the base to prevent the wire connections from coming loose.

In recognition of these cumbersome, time consuming procedures several patents have attempted to address this problem.

U.S. Pat. No. 4,283,107 issued to Anthony, divulge a two-piece socket assembly with puncturing terminals protruding from the end of the sockets main body. A second cover piece is pivotally mounted on the body and closes over the puncture pins when said cover is screwed down over the wire.

U.S. Pat No. 5,823,322 issued to Bates, embody a socket assembled without tools by inserting wire into a channel in the socket base. Then snap a rotatable switch actuator, which drives two pin sets into both sides of the wire.

The above patents require a complete redo of the socket. History has proven that change in a market place comes very slow.

Companies are hesitant to grasp any idea that requires a complete change of tooling and a big outlay of money. Especially in a market that does not recognize the need.

The present invention considers this, and makes use of certain parts of the socket. Such as the two piece Brass shell, screw shell and the cardboard insulating sleeve. The present invention is safer and easier to wire then what is being sold in stores today. Only requiring the insertion of the lamp wire and tightening the two screws. This connection will hold a 35-lb. weight for 24 hours or more without pulling apart or losing electrical connection.

The present invention eliminates the need to tie a knot in the insulated wire at the base of the lamp to prevent the electrical connection from coming loose.

### SUMMARY OF THE INVENTION

It is accordingly a primary object of this invention to market and produce a novel lamp socket yet keeping the end cost in line with lamp sockets being sold to the public today.

It is another object of this invention to provide a novel socket assembly making use of certain existing parts of the socket that are known and presently sold in stores today, such as the two piece outer brass shell, the cardboard insulation and the screw shell.

It is yet another object of this invention to enable an electrical connection to be made quickly and conveniently with only the tightening of two screws.

A still further object of this invention is to provide a safer electrical connection. Other advantages and salient features of this invention will become clear from the following detailed description when read in conjunction with the accompanying drawings.

### BRIEF DESCRIPTION OF THE DRAWINGS

FIGS. 1-3 is a simplified elevation of a conventional lamp screw shell modified in accordance with the concept of the present invention.

FIG. 1 shows contact screw number 1 penetrating the lamp wire.

FIG. 2 is also a simplified elevation opposite of FIG. 1 showing contact screw number 2 penetrating the lamp wire.

FIG. 3 is a side elevation showing the two screws penetrating the lamp wire.

FIG. 4 is a bottom view of the socket and the close fitting channel for the lamp wire with the two penetrating screws.

FIG. 5 is a sectional view showing the contact screw penetrating the lamp wire and at the same time causing a bulge in the wire.

FIG. 6 is a detailed front and side view of the lamp wire and the effect of the screw penetrating the wire.

FIG. 7 is an alternate layout of the present invention with the lamp wire being split and inserted in a hole not a channel.

FIG. 8 is again the alternate layout showing the bottom sectional view of the socket and the two holes for the lamp wire, the two screws for making contact, minus the lamp wire.

### DRAWINGS—REFERENCE NUMERALS

10-screw shell 12-center contact conductive strip 14-screw shell conductive strip 16-insulated base 18-lamp wire 20-contact screw 22-contact screw opposite side 24-screw hole 26-screw hole opposite side 28-channel for lamp wire 30-front view of bulge 32-side view of bulge 34, 36-alternate layout contact screw 38, 40-alternate layout lamp wire holes

### DETAILED DESCRIPTION OF THE INVENTION

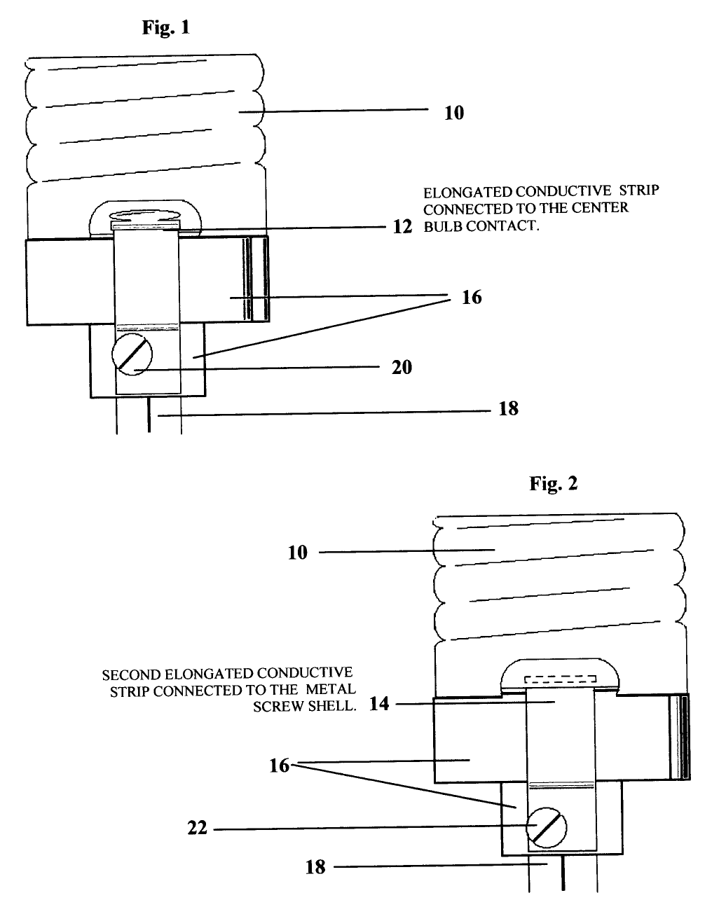

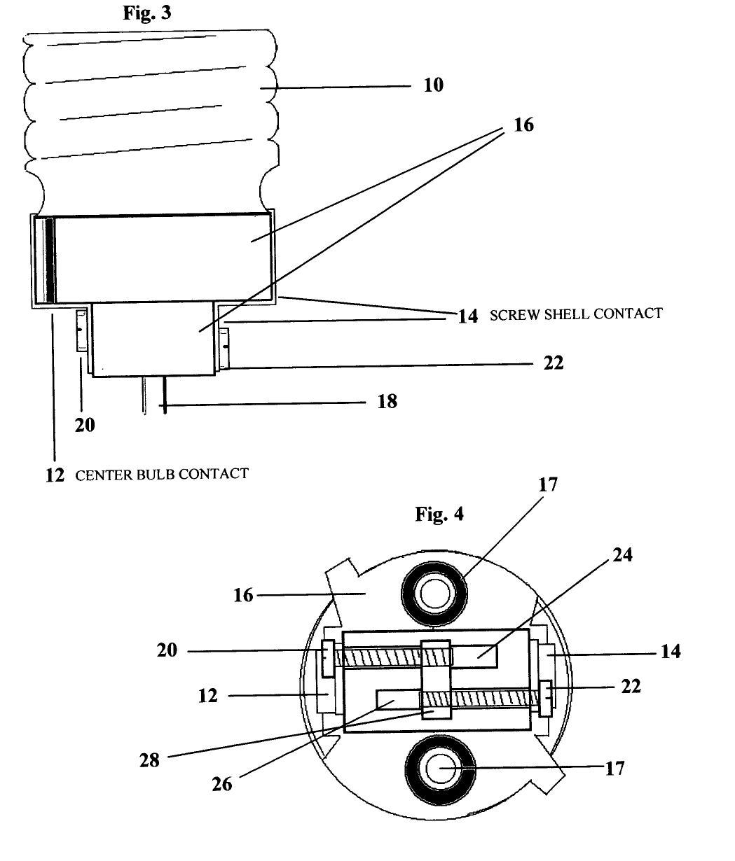

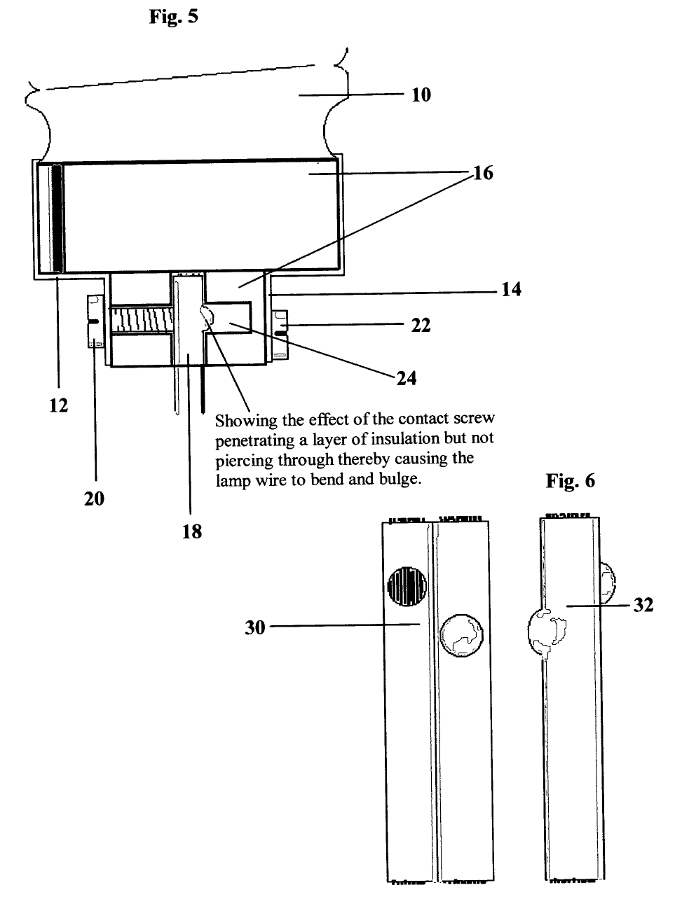

Referring now to the drawings, the invention in one embodiment is shown generally in (FIG. 1 side view) and (FIG. 2 opposite side). A common metal screw shell 10 (FIGS. 1-3) the type used in present day assembly is riveted to an insulated base or disc 16 (FIGS. 1-5) with two rivets. The base is made of plastic or other insulating material. The bulb opening is defined by center contact 12 an elongated conductive strip of approximately 20 thousands of an inch thick and approximately 250 thousands of an inch wide that extends down the side of the base 16. Contact 12 has a hole to accommodate contact screw 20 this hole would be positioned above center to assure no interference with contact screw 22 in (FIG. 2 opposite view of FIG. 1). Contact screw 22 would be positioned below center to assure no interference with contact screw 20. Contact screws 20 and 22 both penetrate insulated lamp wire 18 shown in (FIGS. 1-3) making electrical contact from opposite directions. Contact 14 in (FIGS. 1-5) is connected to the base of the screw shell 10 and is also an elongated conductive strip extending down the side of the base 16 in the same manner as center contact 12 thereby completing the electrical connection. FIG. 4 (bottom view) shows the two penetrating screws and the close fitting channel 28 for the insertion of the insulated lamp wire (not shown) the channel is approximately three eighths of an inch deep. Contact screws 20 and 22 are of a thickness greater then the strands of lamp wire to provide a pressing as well as a penetrating result when making electrical contact. The results of the pressing and penetrating can be seen in (FIG. 5 sectional view).

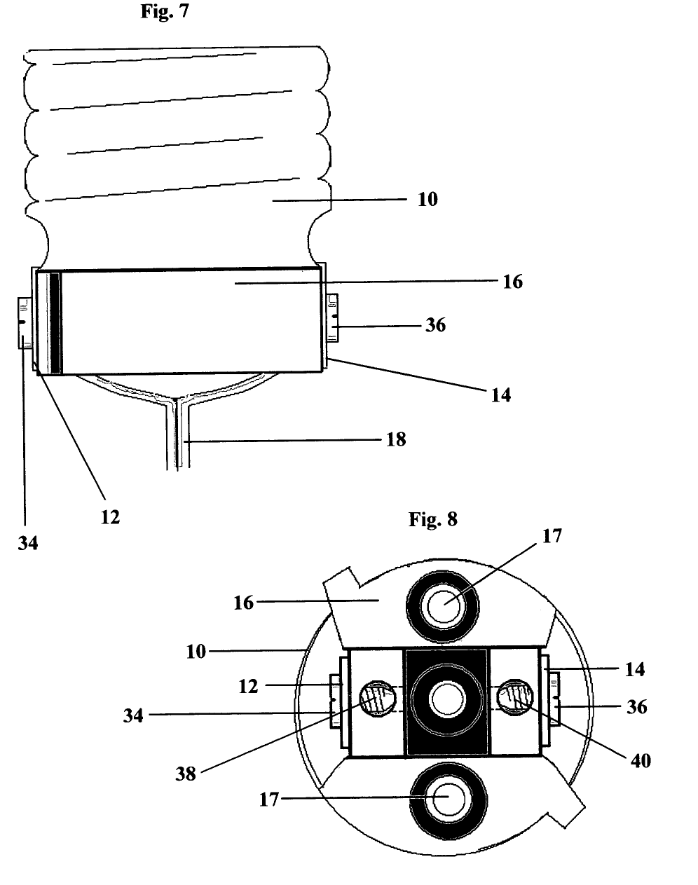

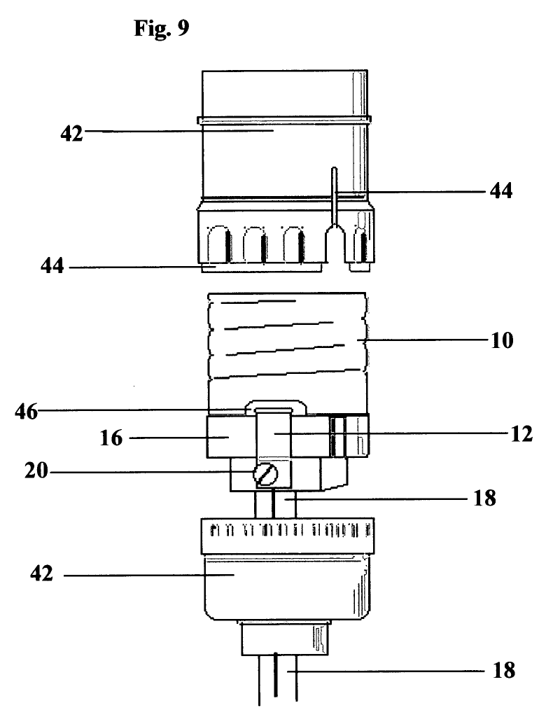

The lamp wire 18 is being penetrated by contact screw 20 and at the same time being pressed into screw hole 24 causing a bulge and wedging effect. The effect on the insulated lamp wire due to the penetrating and pressing can be seen close-up in (FIG. 6) 30 is the lamp wire from the front view and 32 is the lamp wire from the side view, both showing the type of bulge caused by the contact screws pressing and wedging the back part of the insulated lamp wire further into the contact screw hole.

Accordingly, for the penetrating of the lamp wire and the bulge and wedging to exist as in FIG. 6 the contact screw must be a determined size and press the insulated lamp wire approximately three threads deep into the contact screw hole (as shown in FIG. 5). Whereby permitting a very secure and safe connection that will hold a 35-lb. weight in tension for 24 hours or more without pulling apart or losing electrical contact.

Advantages

From the description above, a number of advantages of my improved lamp socket become evident:

(a) Only requires a redo of the insulated base of the common socket being sold today, not a complete redo of the entire socket.

(b) Will fit into the standard two-piece brass shell, switched or non-switch.

(c) A competitive market price.

(d) Simple wiring only requiring the tightening of two screws.

(e) Safer, when the screw is tighten and the bulge is caused an electrical connection is made that will hold a 35-lb. weight in tension for 24 hours.

(f) Can easily be adapted for commercial lamp wiring by making the channel for the lamp wire larger.

(g) Eliminates the need to tie a knot out of the insulated wire at the base of the lamp for additional security.

(h) Substantially reduces the lamp manufactures and the public's assembly time.

(i) The wiring does not depend on the skill of the operator.

(j) The feeling of security when tightening the two screws home.

Conclusion, Ramifications, and Scope

Accordingly, the reader will see this invention is novel yet recognizable, although the benefits are many the cost will be in-line with lamp sockets being sold in stores today. It provides an improvement along with realistic cost and permits an otherwise sleepy industry to wake up and make room for further advances and benefits in the future for the public.

Although the description above is detailed, this should not be construed as limiting the scope of this invention but as merely providing illustrations of some of the presently preferred embodiments of this invention.

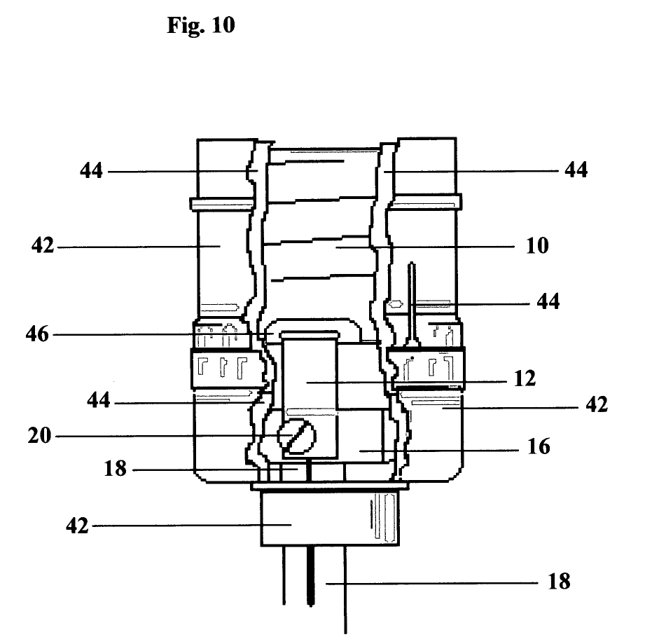

For example, FIG. 7, FIG. 8 show an alternate arrangement where the two conductive strips go straight down the sides of the insulated base similar to the above description. Contact is still made with two contact screws 34, 36 the difference being the lamp wire is split and is inserted in two holes 38, 40 not a channel.

Thus the appended claims and their legal equivalents should determine the scope of the invention, rather then by the examples given.

I claim:

1. A socket assembly comprising a common screw shell and an insulated base the improvement wherein said insulated base has a close fitting channel approximately center of said insulated base for the insertion of electrical wire.

2. The socket assembly of claim 1 wherein said insulated base has two conductive strips extending down said insulated base one from said screw shell the other from the central contact for the bulb.

3. The socket assembly of claim 1 wherein said conductive strips are on opposite sides of said insulated base.

4. The socket assembly of claim 1 wherein said conductive strips are elongated.

5. The socket assembly of claim 1 wherein said conductive strips each have a hole for screws one positioned above center the other positioned below center.

6. The socket assembly of claim 1 wherein said insulated base has two threaded screw holes inline with said conductive strip screw holes said insulated base threaded screw holes go through said close fitting channel.

7. The socket assembly of claim 1 wherein said conductive strips and said insulated base have two contact screws opposite each other whereby upon insertion of the insulated lamp wire and the tightening of the two contact screws electrical contact is made quickly and safely.

8. The socket assembly of claim 7 wherein said contact screws upon penetrating and pressing said insulated lamp wire into said insulated base screw hole cause a bulge and wedging effect.

9. The socket assembly of claim 8 wherein said bulge and said wedging effect whereby produce an electrical connection that will hold a 35-lb. weight for 24 hours or more without pulling apart or losing electrical connection.

10. The socket assembly of claim 1 wherein said screw shell and said insulated base fit into the common brass shell with cardboard insulation.

11. Providing electrical contact in a novel and unexpected configuration comprising:
(a) a screw or device that upon turning or pressing penetrates the insulation of electrical wire whereby making electrical contact.
(b) said screw or device in penetrating the insulation of the electrical wire and making electrical contact will at the same time press the wire in a hole or crevice causing a bulge or wedging effect whereby said screw along with said bulge is capable of holding the wire in tension with a 35-lb. weight for 24 hours or more without pulling apart or effecting the electrical connection whereby making electrical contact in a novel manner.

12. Providing electrical contact comprising a screw:
(a) said screw having a predetermined size thereby upon being turned or pressed makes electrical contact and at the same time causing a bulge in insulated lamp wire whereby sandwiching said lamp wire with said screw and screw hole.
(b) thereby said bulge provides an electrical connection that will hold a 35-lb. for many hours without coming loose or losing electrical contact.
